(19) United States
(12) Patent Application Publication
(10) Pub. No.: US 2014/0302460 A1
(43) Pub. Date: Oct. 9, 2014

(54) DENTAL IMPLANT AND METHOD FOR PRODUCING A DENTAL IMPLANT

(71) Applicant: Ivoclar Vivadent AG, Schaan (LI)

(72) Inventor: Sascha Cramer Von Clausbruch, Muhlacker/Lienzingen (DE)

(21) Appl. No.: 14/342,217

(22) PCT Filed: Jan. 24, 2013
(86) PCT No.: PCT/EP2013/051354

§ 371 Date: Feb. 28, 2014

(30) Foreign Application Priority Data
Jan. 25, 2012 (DE) 10 2012 201 092.0

(51) Int. Cl. A61C 8/00; A61C 13/083

(52) U.S. Cl. CPC A61C 8/0075; A61C 13/083
USPC 433/201.1

(57) ABSTRACT

In a dental implant (20) comprising an implant body (30) for the insertion into the jaw (14) of a patient, and comprising a mounting section (54) with a through-passage recess for a bolted connection (70) that may be screwed into the implant body for the releasable attachment of the mounting section (54) to the implant body, a superstructure (52), in particular a crown, is provided that at least forms the major part of an outer surface of at least one dental restoration. The mounting section (54) and the implant body releasably mesh with one another via engagement elements that have at least one inclined plane departing from the circular shape, in particular a multi-sided profile or polygon. The superstructure (52) and the mounting section (54) are formed as an integral structural member (50) made from the same material.

The invention relates to a dental implant according to the preamble of claim 1.

Dental implants known usually comprise an implant body that for the intended purpose is screwed into the jaw bone of a patient by means of an external thread, or that is attached therein in any other way and integrates with the bone.

Typically, in implant prosthetics the superstructure of the dental implant, that is to say normally the respective crown, is attached to the implant body via a separate connection element, a so-called abutment. Both abutments made from titanium and aluminum oxide ceramics and zirconium dioxide ceramics are used, whereby a good biocompatibility is desired as the abutment normally is in contact with the gingiva.

Abutments for the most part are made so that a secure fit and anchorage both with regard to the crown and the implant body is ensured. By means of the abutment the exact position, i.e. the altitude, if necessary the inclination in the mesio-distal direction, the angular position, is to be defined in 5 dimensions. Such an abutment for the most part is embodied as a molded body with a vertical axis, about which it extends in a circular symmetrical manner. A bolted connection or an adhesive joint may be realized, but also press-fitting is possible.

Prefabricated abutments have the disadvantage that they often can not-so-well be fit into the row of teeth in the patient's mouth, and a change of shape is difficult due to the hard material (titanium, ZrO₂). That renders the production of the superstructure problematic.

Therefore, also individually fabricated abutments are used recently. However, those require a high time and cost expenditure.

The crown or superstructure either comprises a metal frame that is veneered with ceramics for example, or it consists of ceramics or a composite. If the connection between the crown and the implant body is effected via the mentioned bolted connection, the screw must be tightened with an exactly given torque in order to prevent masticatory forces being able to disconnect the connection. If a cement or adhesive joint is employed that can be used to connect the abutment with the superstructure, peri-implantitis, i.e. a loss of bone in the area of the implant body, might be incurred. Moreover, the dental implants used so far are comparatively expensive and elaborate.

From WO 99055249 A1 it has become known to integrate the abutment into the implant body. For this purpose, the implant body comprises two parts, i.e. a metal core and a cladding made from ceramics or a composite material. The crown comprises an inner cone that is supposed to fit on the truncated cone retention shape of the implant body. In order to ensure a good bonding or connection, the crown comprises a relatively small cone angle so that the lower supra-gingival areas of the crown turn out relatively thin. In order to prevent the crown from breaking at this position, the above solution preferably provides an adhesive bond of the crown despite of the disadvantages known.

On the other hand, the invention is based on the object of providing a dental implant according to the preamble of claim 1 permitting a safe mounting of the superstructure at a low cost.

According to the invention, a mounting section and the superstructure are formed as an integral structural member made from the same material.

Hence, in case of an inventive dental implant two structural components, i.e. a separate superstructure and a separate mounting section (abutment), are not connected to the implant body one after the other, but only the above-mentioned one-pieced or integral structural member. It is attached to the implant body via a bolted connection.

For this purpose, the integral structural member is provided with a through-passage recess that extends from the superstructure through the mounting section. The mounting screw runs within said screw connection channel or said through-passage recess and internally contacts the mounting section with its conical screw head so that it cannot fully slip therethrough. At least some sections of the screw connection channel comprise a smaller diameter than the screw head.

According to the invention both at the mounting section of the crown and the implant body, engagement elements having each at least one inclined plane departing from a circular form, in particular a multi-sided profile or polygon, are provided. Those releasably mesh with one another.

Surprisingly, such engagement elements can also be produced if the crown is milled from a blank, in particular, if the engagement elements at the crown face to the outside, i.e. for example are embodied as an external multi-sided profile or polygon. In this way, the form fit or positive locking function of abutments and also the adjustment possible there, can be fully adopted by the connection of the superstructure with the implant body.

The integral structural member forming the mounting section and the superstructure is preferably formed as a milled component. The accuracy of milling machines used in the dental field is sufficiently high in order to provide the necessary precision. By means of the milling process the mentioned through-passage recess can be produced within the structural member as well. Instead of producing the integral structural member as a milled component, it is also possible to produce it by means of a rapid prototyping process such as 3D printing and SLM (Selective Laser Melting).

Due to the fact that the integral structural member in the area of the superstructure at least in sections forms the outer surface of the replacement tooth or dental restoration, it is produced from a material that approximately corresponds to the color of teeth. Preferably, the superstructure that is formed by the integral structural member, forms the entire surfaces of the tooth except for the access to the through-passage recess. Conventional ceramic materials in the dental field, e.g. oxide ceramics such as zirconium dioxide or silicate ceramics such as lithium disilicate, can be used as the material for the integral structural member. The ceramic materials mentioned offer material properties with regard particularly to hardness and breaking strength that both take account of the intended purpose as a dental prosthesis and the fact that the integral structural member also is under mechanical load due to the attachment to the implant body. Basically, however, composites or plastics may be used as well.

In an advantageous embodiment the mounting section to the crown has the shape of an integral truncated shaped pin at its lower end, whereas engagement elements that are suitable for the transmission of torque are provided at this position of the mounting section, preferably at the apex or tip of the cone.

A anti-spin support of the crown is effected via opposite engagement elements that are formed at or within the implant body and into which the engagement elements of the crown are inserted.

In this manner, the pin-shaped mounting section of the crown is securely surrounded and supported by the implant body which benefits the support safety.

The number of the possible relative angle positions between the implant body and the crown may be adapted to the requirements to a large extent. In this way, the engagement element facing inward preferably can have a finer pitch than the engagement element facing outward. An external hexagon at the pin of the crown may for example be combined with a 15-degree pitch of grooves within the implant body.

After the attachment of the mounting section of the integral structural member, the through-passage recess for the mounting screw may be closed with a filling material in a manner known per se. Suitable materials are conventional materials in the dental field that harden in the mouth of the patient. Such plastics are known as filling plastics, repair plastics and veneer plastics. In the case that an access to the mounting screw is required after the dental implant has been inserted into the mouth of a patient, it is normally possible to again remove the material used.

The attachment of the integral structural member to the implant body preferably is exclusively effected via the above-mentioned bolted connection. The mounting screw thus is the only means of attachment that counteracts the separation of the integral structural member from the implant body. Consequently, the use of an adhesive or dental cement can be completely avoided.

The integral body consisting of the crown and the attachment section, as well as the implant body are preferably matched to one another so that they first of all positively counteract a rotary relative movement regardless of the screw connection by contact with one another. For this purpose for example, they may comprise corresponding hexagonal sections or other sections departing from the circular shape that cause a positive form locking counteracting such a relative movement. Those sections that serve as a spin-lock, may have the shape of a cylinder or also a pyramid section and may be shaped in a male and female form in order to match one another.

The implant body preferably is a body that does not comprise sections itself that project beyond the gingiva of the patient into the mouth area. Instead, the implant body predominantly extends into the jaw bone of the patient as intended and only slightly extends into the gingiva of the patient.

A process for producing an attachment section and a superstructure are provided in which process the attachment section and the superstructure are made in one piece or integrally. The term “one-pieced” means that the later attachment section and the later superstructure already in the stage of original forming, i.e. for example at the production of a ceramic blank, are formed integrally.

Preferably, the superstructure is produced via milling from a blank of preferably sintered ceramics, in particular oxide ceramics such as circonium oxide.

The inventive assembly of the dental implant is effected by connecting the mentioned integral structural part comprising the attachment section and the superstructure via a screw connection to the implant body, and after that the part of the through-recess above the screw head is closed by means of a dental filling material.

Further details, advantages and features emerge from the following description of preferred exemplary embodiments of the invention, in which:

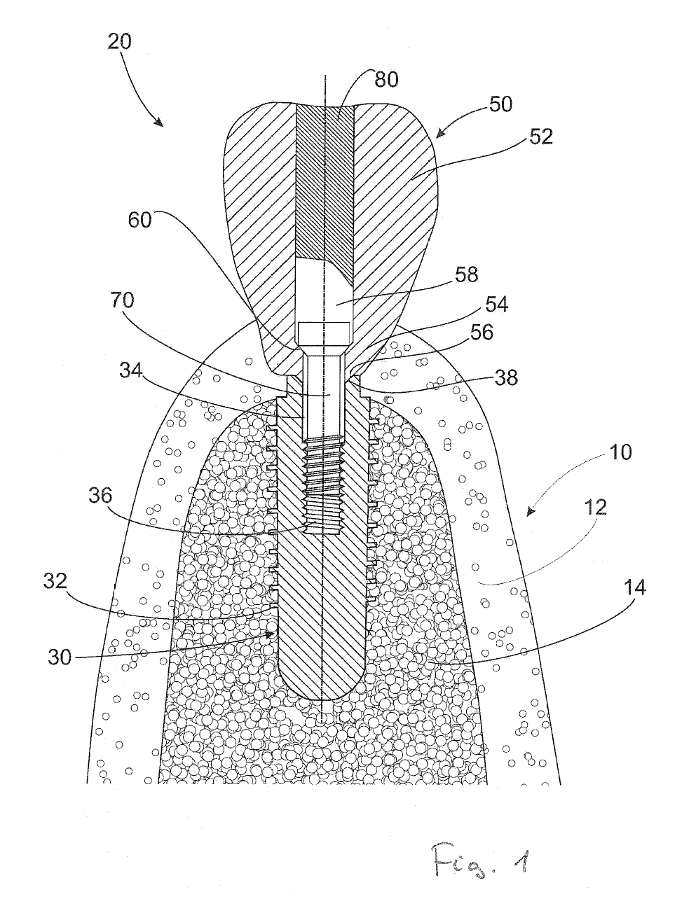

FIG. 1 shows a sectional view of an inventive dental implant in a first embodiment;

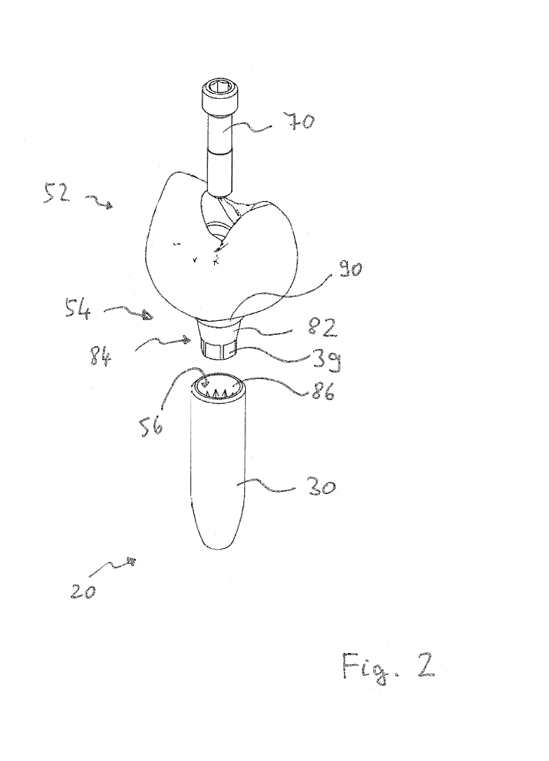

FIG. 2 shows a perspective view of a further embodiment of a dental implant according to the invention; and

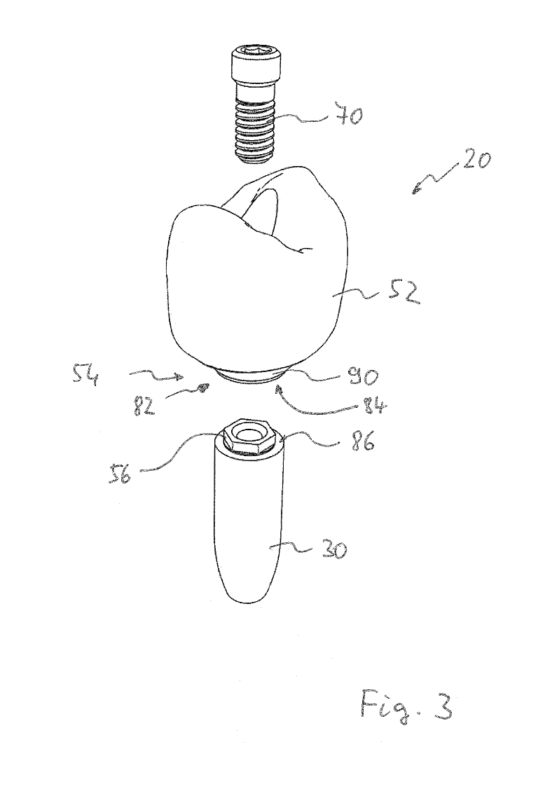

FIG. 3 shows a perspective view of a third embodiment of an inventive dental implant.

According to FIG. 1 a dental implant 20 is shown that has already been inserted into the jaw of a patient. FIG. 1 shows a section through the jaw 10 of the patient whereby different filling structures indicate the jaw bone 14 and the surrounding gingiva 12.

The dental implant 20 inserted into the jaw of the patient comprises an implant body 30. Said implant body 30 is similar to those known from the prior art. The implant body comprises an approximately cylindrical basic shape and comprises a threaded structure 32 at its outer surface that serves for insertion into and integration with the jaw bone.

Preferably, the implant body 30 is designed not to protrude through the gingiva 12 of the patient into the mouth area.

Starting from its upper front side a threaded recess 34 extends within the implant body. An internal thread 36 is provided in the threaded recess. A conical recess (female) is provided at the front entry of the screw channel 34, which conical recess is not round (not shown in FIG. 1), for example has the shape of a three-sided, four-sided, six-sided or multi-sided pyramid section, and forms engagement elements 38 of the implant body 30.

A structural member 50 both comprising a superstructure 52 and a mounting section 54, is attached to the implant body 30. The superstructure 52 forms the major part of the tooth replacement areas projecting beyond the gingiva 14. The mounting section 54 that integrally connects to the superstructure 52, extends subgingivally to the implant body 30. In conformity with the implant body 30, the attachment section 54 in the present exemplary embodiment also comprises engagement elements 56 shaped in pyramid sections that face downwards and outwards. Preferably, in conformity with the conical recess of the implant body 30, too, they are also provided with inclined surfaces that depart from the rotationally symmetric shape and preferably have the shape of pyramid sections so that the structural member 50 put onto the implant body 30 is locked against turning in a form-locking manner through mutual contact.

Alternatively to the illustrated design, the form lock may also be realized by providing a male configuration at the implant body 30 as well as a female configuration in form of a recess at the structural member 50.

The complete attachment of the structural member 50 is effected via a screw 70. The screw is inserted via a through-passage recess 58 of the structural member 50, whereby a conical seat 60 at the lower end of the through-passage recess 58 forms an end stop for the screw head that is conical at this position, too. The screw 70 is screwed into the internal thread 36 and provides a secure and non-rotating support of the structural member 50 at the implant body 30 due to the structures 38, 56.

The cone angle of the seat 60 here corresponds to the cone angle of the conical recess and amounts to 45 degrees relative to the screw axis here. Due to the fact that the superstructure also tapers in its mounting section 54 towards the implant body 30, a material thickness may be achieved at this position in a simple manner that is comparatively large and constant across the run in the vertical direction, i.e. that may correspond to half the diameter of the implant body, or that may be somewhat larger or smaller than the diameter.

The through-passage recess 58 is filled with a dental filling material or compound 80, in particular from plastic material, in order to form a uniform outer surface. If it is required later to achieve access to the screw 70, the filling material 80 can easily be removed again.

The dental implant according to invention with the dental implant 30 substantially corresponding to the design of implant bodies already known, and with the integral structural member 50 combining therein the mounting section 54 and the superstructure 52, provides a cost-efficient configuration of a dental implant. The need for connecting components of the dental implant by means of an adhesive or dental cement is removed so that the effort or cost for providing the patient with a dental implant is reduced and the danger of postoperative complications is decreased.

FIG. 2 in a perspective view illustrates a further embodiment of the dental implant 20. For reasons of clarity of the illustration, the three components of the dental implant 20, i.e. the mounting screw 70, the superstructure 52 and the implant body 30 are illustrated separately each, whereas it is to be understood that these three components are engaged with one another in the assembled condition.

In the illustrated exemplary embodiment engagement elements 38 at the mounting section 54 are embodied as a hexagon. In a manner known per se, such a hexagon comprises six inclined planes 39 that each extend at an angle of 60° to one another, in fact parallel to the axis of the mounting screw 70.

The inventive planes 39 in this respect not only can have the shape of a truncated pyramid according to FIG. 1, but can also be embodied as inclined planes 39 of a hexagon according to FIG. 2.

The engagement element 38 merges into a taper 82 that protrudes from the superstructure 52 in a pin-like manner. The taper 82 comprises a cone angle of approximately 15° relatively to the axis of the mounting screw 70 and forms a contact surface 84 for a corresponding counter contact surface 86 at the implant body 30.

A truncated cone shaped connection 90 is provided that follows the taper 82 in the occlusal direction, which truncated cone shaped connection 90 by the way connects flush to the superstructure 52.

In the illustrated exemplary embodiment the engagement element 56 is formed by an inner double hexagon that is formed within the implant body 30 above an internal thread according to the internal thread 36 of FIG. 1. It is to be understood that instead the engagement element 65 can optionally also be embodied as a 18-point polygon or as a 24-point polygon in order to enable a corresponding precise angular alignment.

Due to the masticatory forces within the mouth of a patient, in particular shearing forces are exerted on the superstructure 52 that are absorbed by the contact surfaces 84, 86 and that are conducted away into the implant body 30. Additionally, also torques along the vertical axis of the mounting screw 70 are introduced through the masticatory motion to a small extent, which torques are picked up and conducted away by means of the engagement elements 38 and 56.

FIG. 3 illustrates a modified embodiment of the inventive dental implant 20. Identical reference numbers here as well as in the further figures refer to the same parts and do not require further explanation.

The engagement elements 56 of the implant body 30 in this exemplary embodiment are embodied as an external hex that is provided at the upper edge of the implant body 30 and that clearly recedes relative to the outer diameter of the implant body. Appropriately, engagement elements 38 are provided as an internal polygon at the mounting section 54 in a manner not illustrated in FIG. 3 so that a corresponding angular fixation may be achieved by means of the engagement of the engagement elements 38 and 56 into one another.

In this exemplary embodiment a truncated cone shaped connection 90 of the superstructure 52 is provided in such a way that the outer surface of the super-structure 52 and the outer surface of the implant body 30 merge flush with one another when attached to one another. The attachment surfaces 84 and 86 at the superstructure 52 and at the implant 30 that face one another are exactly formed to fit one another having a dimensional deviation that is very small and for example can only amount to 20 or 50 μm. By means of postprocessing after the milling process, such as by means of polishing for example, a very small surface roughness may be achieved, and the retention force of the mounting screw 70 enables a gap-free connection between the implant body 30 and the superstructure 52.

1. A dental implant comprising
an implant body for the insertion into a jaw of a patient,
a superstructure and a mounting section formed as an integral structural member made from the same material;
the mounting section having a through-passage recess for a bolted connection that may be screwed therein for the releasable attachment of the mounting section to the implant body;
the superstructure forming at least the major part of an outer surface of at least one dental restoration,
wherein the mounting section and the implant body each comprise engagement elements that each have at least one inclined plane departing from a circular shape, said engagement elements meshing with one another in a releasable manner.

2. The dental implant as claimed in claim 1, characterized in that wherein the integral structural member forming the mounting section and the superstructure is formed as a milled component.

3. The dental implant as claimed in claim 1, wherein the through-passage recess in the integral structural component comprises a conical seat that it is closed with a dental filling material at one end thereof.

4. The dental implant as claimed in claim 1, wherein the attachment of the mounting section of the integral structural component to the implant body is exclusively effected by means of the bolted connection.

5. The dental implant as claimed in claim 1, wherein the engagement elements at the mounting section of the superstructure are formed at inclined planes that face outwards relative to the axis of the bolted connection.

6. The dental implant as claimed in claim 1, wherein the engagement elements at the mounting section of the superstructure are formed at inclined planes that face inwards relative to the axis of the bolted connection.

7. The dental implant as claimed in claim 1, wherein the engagement elements at the mounting section are formed by a polygon and wherein the engagement elements of the implant body are formed by a counter-form comprising an integer multiple of the inclined planes of the engagement elements.

8. The dental implant as claimed in claim 1, wherein the engagement elements are formed at a lower end of the mounting section that faces towards the implant body and fully mesh with the engagement elements of the implant body when fitting the superstructure on the implant body.

9. The dental implant as claimed in claim 1, wherein the superstructure comprises a conical taper at the end thereof facing towards the implant body at which it tapers to the diameter of the implant body and forms a flush transition to the implant body.

10. The dental implant as claimed in claim 1, wherein the contact surfaces at the mounting section and the contact surfaces at the implant body are each formed by machining and exactly have the same shapes matching one another.

11. The dental implant as claimed in claim 10, wherein the contact surfaces are formed with a dimensional variation and surface roughness of less than 50 μm.

12. The dental implant as claimed in claim 1, wherein the taper at the mounting section comprises a larger cone angle in the occlusal direction and a smaller cone angle in the gingival direction.

13. The dental implant as claimed in claim 1, wherein both the superstructure and the implant body are integrally formed, with regard to the superstructure except for a filling material if necessary.

14. The dental implant as claimed in claim 1, wherein the cone angle of the head of the mounting screw substantially corresponds to a taper angle of a taper at the outside of the mounting section.

15. The dental implant as claimed in claim 1, wherein the integral structural member is made from glass ceramics.

16. The dental implant as claimed in claim 1, wherein the integral structural member comprises plastics or a composite.

17. The dental implant as claimed in claim 1, wherein the superstructure comprises a crown.

18. The dental implant as claimed in claim 1, wherein the engagements elements each have a multi-sided surface or polygon.

19. The dental implant as claimed in claim 2, wherein the superstructure is fabricated of ceramics, preferably oxide ceramics.

20. The dental implant as claimed in claim 19, wherein the ceramics comprise oxide ceramics.

21. The dental implant as claimed in claim 7, wherein the polygon comprises a square or a hexagon.

22. The dental implant as claimed in claim 15, wherein the glass ceramics comprise lithium disilicate.
